(19) United States
(12) Patent Application Publication
(10) Pub. No.: US 2004/0247144 A1
(43) Pub. Date: Dec. 9, 2004

(54) Sound reproduction systems

(76) Inventors: Philip Arthur Nelson, Romsey (GB); Takshi Takeuchi, Tokyo (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/488,494

(22) PCT Filed: Sep. 27, 2002
(86) PCT No.: PCT/GB02/04363

(30) Foreign Application Priority Data
Sep. 28, 2001 (GB) 0123493.9

(51) Int. Cl. H04R 5/02

(52) U.S. Cl. 381/300; 381/307; 381/310; 381/303

(57) ABSTRACT

The sound reproduction system is of the kind which comprises electro-acoustic transducer means, and transducer drive means for driving the electro-acoustic transducer means in response to a plurality of channels of a sound recording. The electro-acoustic transducer means comprises sound emitters which are spaced-apart in use, the transducer drive means comprising filter means that has been designed and configured with the aim of reproducing at a listener location an approximation to the local sound field that would be present at the listener's ears in recording space, taking into account the characteristics and intended positioning of the sound emitters relative to the ears of the listener, and also taking into account the head related transfer functions of the listener. The invention concerns the fact that the electro-acoustic transducer means comprises at least one pair of sound emitters that are spaced from the interaural axis of the listener at the listener location and positioned substantially in a plane that includes said interaural axis and is inclined relative to a reference horizontal plane that also includes said interaural axis, the angle of inclination of said inclined plate relative to said horizontal plane being in the range 60° to 120°. The pair of transducers will usually be positioned higher than the head, and the preferred angle of inclination of said plane is in the range 75° to 105°.

This invention relates to sound reproduction systems.

The invention is particularly, but not exclusively, concerned with the stereophonic reproduction of sound whereby signals recorded at a plurality of points in the recording space such as, for example, at the notional ear positions of a head, are reproduced in the listening space, by being replayed via a plurality of speaker channels, the system being designed with the aim of synthesising at a plurality of points in the listening space an auditory effect obtaining at corresponding points in the recording space.

### 1 INTRODUCTION

### 1.1 BACKGROUND OF THE INVENTION

The development of both the ‘Stereo Dipole’ [1] (and Patent Specification WO 97/30566) and the ‘Optimal Source Distribution’[2] (and patent Application No. PCT/GB01/02759 filed 22 Jun. 2001) virtual acoustic imaging systems dealt with the azimuth location of the control transducers. In the past, the elevation location of transducers for binaural reproduction over loudspeakers has received even less attention than the azimuth location. In most of the past research, the transducers are usually placed on the horizontal plane that includes the listener's head. This convention is probably adapted from the Stereophony for which the virtual images are perceived at the same elevation as the transducers. Since the majority of the sound sources in everyday life are on the horizontal plane, as a consequence of the fact that most objects are on the ground, placing transducers on the horizontal plane was a natural choice. Sometimes the transducers had to be placed slightly above or below the horizontal due to physical constraints. However, since the binaural technique enables in principle the synthesis of sound waves from any direction, there is no reason to restrict the transducer position to the horizontal plane.

We discuss hereafter in Section 5 some work which shows that binaural synthesis over loudspeakers can also be made to operate remarkably effectively when the control transducers are not in the horizontal plane in front of the listener.

It has been known that the most significant error in binaural reproduction is front-back confusion. In cases of loudspeaker synthesis, this often results in bias error where a rear image is perceived in front, i.e., towards the control transducer direction [3]. When the transducers are placed around the frontal plane, this bias error is expected to be unlikely, being at the border of the front and rear hemispheres.

In order to find out the characteristics of various elevation positions of the control transducers, the analysis of the spectral cues and dynamic cues was performed. Positions in the frontal plane generally above the listener's head were found to be promising as alternative control transducer location. A subjective experiment was performed in order to compare between two alternative control transducer locations, 0° elevation and 90° elevation. For convenience the interaural polar co-ordinates (FIG. 1) are used throughout this specification since they coincide with the characteristics of the human auditory function.

### 1.2 SUMMARIES OF THE INVENTION

According to one aspect of the invention a sound reproduction system comprises electro-acoustic transducer means, and transducer drive means for driving the electro-acoustic transducer means in response to a plurality of channels of a sound recording, the electro-acoustic transducer means comprising sound emitters which are spaced-apart in use, the transducer drive means comprising filter means that has been designed and configured with the aim of reproducing at a listener location an approximation to the local sound field that would be present at the listener's ears in recording space, taking into account the characteristics and intended positioning of the sound emitters relative to the ears of the listener, and also taking into account the head related transfer functions of the listener, wherein the electro-acoustic transducer means comprises at least one pair of sound emitters that are spaced from the interaural axis of the listener at the listener location and positioned substantially in a plane that includes said interaural axis and is inclined relative to a reference horizontal plane that also includes said interaural axis, the angle of inclination of said inclined plane relative to said horizontal plane being in the range 60° to 120°.

By ‘horizontal’ we mean horizontal with respect to the intended head orientation of the listener, which of course will usually be an upright position of the head.

Thus we position the pair of transducers in a plane that has an angle of inclination of between 60° and 120° relative to the horizontal.

Preferably the pair of transducers are positioned higher than the head rather than below but there may be situations where the pair of transducers is advantageously positioned below the head in said inclined plane.

The angle of inclination is preferably in the range 75° to 105°.

The pair of transducers are preferably positioned in the frontal hemisphere but may be in the rear hemisphere.

The electro-acoustic transducer means may comprise more than one pair of transducers. The pairs of transducers are preferably located substantially in a common inclined plane but may be located in different inclined planes, which preferably each extend at a respective angle that is in the range of 60° to 120° to said horizontal plane.

The electro-acoustic transducer means may comprise a pair of on-axis transducers, transducers that are positioned substantially on the interaural axis, on the opposite sides of head position.

When there is a plurality of pairs of transducer means a relatively higher frequency band of the drive output signals is preferably arranged to excite a first of said pairs of sound emitters that subtend a relatively small azimuth angle at the listener head position, and a relatively lower frequency band of the drive output signals is arranged to excite a second of said pairs of sound emitters that subtend a relatively larger azimuth angle at the listener head position.

The filter means preferably comprise inverse filter means, and preferably the inverse filter means comprises cross-talk cancellation filter means.

It is desirable to make use of the filter design techniques discussed in the above-mentioned specifications, No. WO 97/30566 and that of patent application PCT/GB01/02759, but taking due account of the raised, or lowered, positions of the transducers.

### 1.3 BRIEF DESCRIPTION OF THE DRAWINGS

The invention will now be further described, by way of example only, with reference to the accompanying drawings, which show:

FIG. 1 The interaural spherical co-ordinate system used to define the direction of sound sources relative to the listener's head position and orientation. An example of ‘cone of constant azimuth’ is illustrated. The circles parallel to the yz plane on the sphere show directions with constant azimuth. The circles which includes the x axis show directions with constant elevation.

FIG. 2 An arrangement of a 3-way OSD system.

FIG. 3 Experimental rig for the plant measurement.

FIG. 4 Frequency response of the plant of the OSD system for the various elevations. a) plant for the ipsi-lateral ear. b) plant for the contralateral ear.

FIG. 5 Frequency response of the plant of the SD system for the various elevations. a) plant for the ipsi-lateral ear. b) plant for the contralateral ear.

FIG. 6 Frequency response of the HRTFs for the directions on the median plane (calculated from the MIT database).

FIG. 7 Condition number for the plant matrix. a) OSD system. b) SD system.

FIG. 8 Change of ITD for sound sources at various elevation directions corresponding to the yaw rotational displacements.

FIG. 9 Dynamic change of ITD for all virtual source directions produced by the control transducers in conjunction with yaw rotational movement over −40° to 40°. a) control transducers at 0° elevation (in front on the horizontal plane). b) control transducers at 90° elevation (above on the frontal plane) (Example: the SD system.)

FIG. 10 Binaural reproduction over loudspeakers with visual information. a) control transducers around 0° elevation. b) control transducers around 90° elevation.

FIG. 11 Experimental rig for subjective evaluation.

FIG. 12 Tested directions a) top view. b) side view.

FIG. 13 Perceived virtual sound source directions. a) control transducers at 0° elevation. b) control transducers at 90° elevation.

FIG. 14 Azimuth localisation performance. The square marker denotes median and the star marker denotes 25 and 75 percentile. a) control transducers at 0° elevation. b) control transducers at 90° elevation.

FIG. 15 Elevation localisation performance. a) control transducers at 0° elevation. b) control transducers at 90° elevation.

FIG. 16 Perceived virtual sound source directions with false dynamic information by yaw head rotation. a) control transducers at 0° elevation. b) control transducers at 90° elevation.

FIG. 17 Azimuth localisation performance with false dynamic information by yaw head rotation. The square marker denotes median and the star marker denotes 25 and 75 percentile. a) control transducers at 0° elevation. b) control transducers at 90° elevation.

FIG. 18 Elevation localisation performance with false dynamic information by yaw head rotation. a) control transducers at 0° elevation. b) control transducers at 90° elevation.

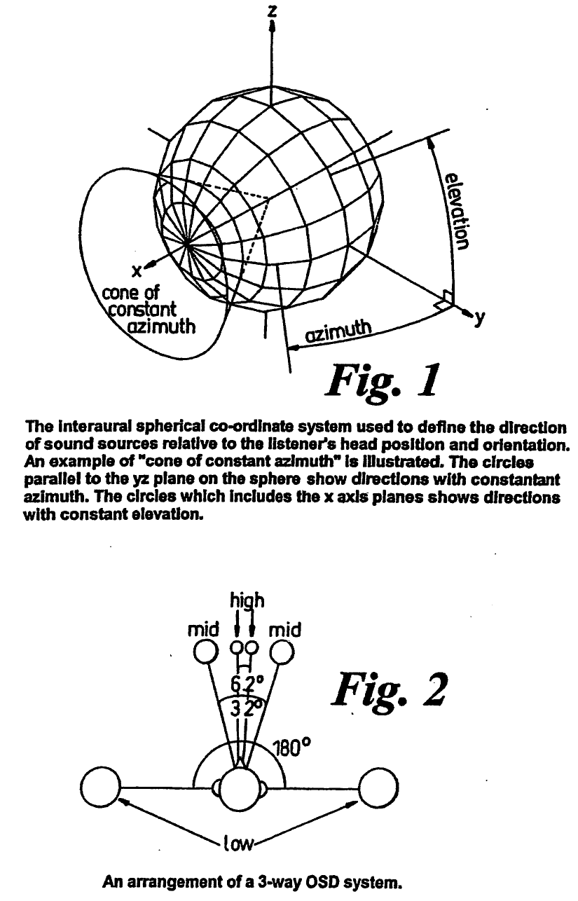

### 2. INVERSION OF THE PLANT

When the plant is inverted, peaks and dips in the plant transfer functions are suppressed or filled by the inverse filters in order to achieve the synthesis of the desired signal spectra. Therefore, a certain amount of dynamic range is lost through this process, i.e. through the compensation of the plant response. In this respect, a flat plant response is preferable than that with significant peaks and dips. Furthermore, it has also been revealed that the mismatch between the individual plant HRTFs and the design plant HRTFs often results in the synthesis of the wrong spectra [3]. The mismatch is most likely to happen where notches exist whose position can vary considerably among individuals and are hence less likely to be cancelled out properly. There may be some elevation directions where the inversion of the plant is easier than the other directions. Therefore, the plant responses for the ‘Optimal Source Distribution’ and the ‘Stereo Dipole’ system were measured in order to study this possibility.

### 2.1 MEASUREMENT OF THE PLANT RESPONSE

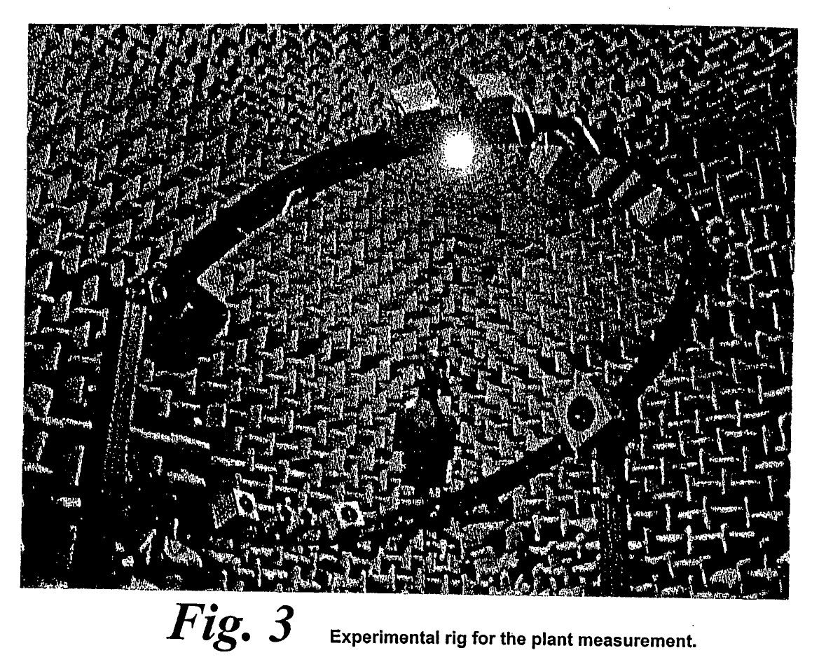

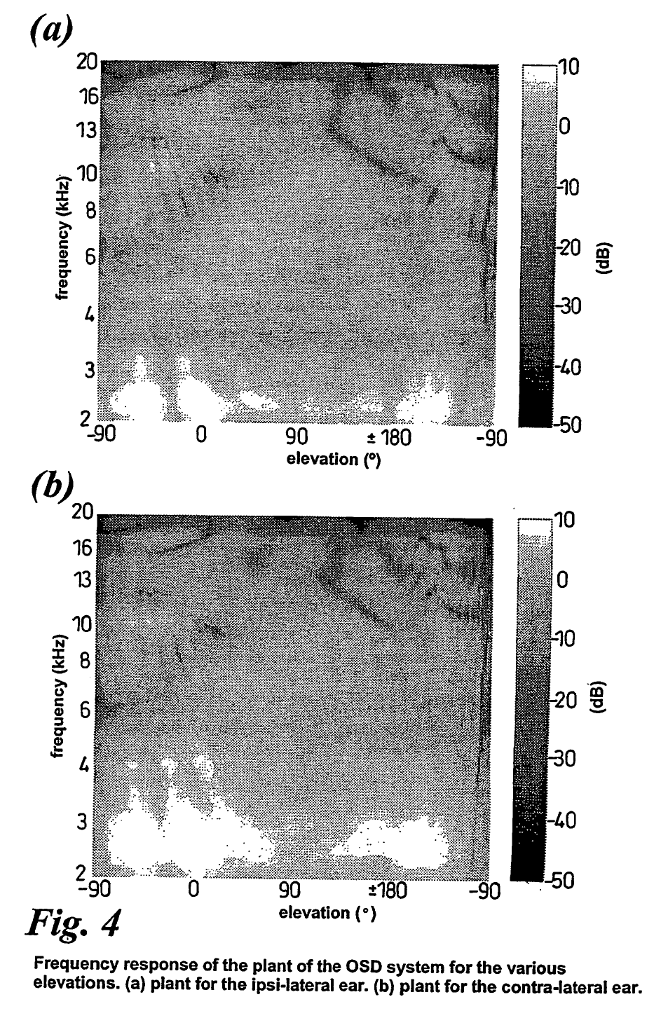

The three way OSD system as illustrated in FIG. 2 was used. A pair of high frequency units spanning 6.2° is chosen to cover the frequency range up to 20 kHz while a pair of low frequency units spanning 180° is chosen to cover as low a frequency as possible. The span for the mid frequency units is 32°. The ‘Stereo Dipole’ (SD) system was defined as 1-way system whose transducers are spanning 10° in the azimuth direction.

Each driver unit covering a different frequency range was chosen to ensure similar characteristics as far as possible. These drivers were enclosed by closed cabinets and mounted on a circular steel frame. This ensured the accurate alignment of the units and the listener's head (FIG. 3). This circular steel frame on which the control transducers were mounted was rotated around the interaural axis at 1° increments from −180° elevation to 180° elevation in order to obtain the plants for various elevation directions. There are gaps of 10° in the regular sampling in the directions centred on −85° and 95° due to the required size and shape of the transducers and the ring. The distance between the units and the centre of the head (at the intersection of interaural axis and median plane) was set to 1.4 m. Among the choice of cross-over filter types, passive cross-over networks were used. Their cut-off frequencies were 450 Hz/3500 Hz for the 3-way OSD system.

The plant matrix was obtained using a maximum length sequence (MLS) measurement technique with the KEMAR dummy head microphones with a sampling frequency of 88.2 kHz in an anechoic chamber. The data were down sampled to 44.1 kHz. The model DB-061 was used for the left pinna and the model DB-065 was used for the right pinna to obtain two sets of plant matrices. However, the data obtained with DB-065 was used for the later evaluation. The free field response of each loudspeaker system was also measured with a free field microphone.

### 2.2 ANALYSIS OF THE PLANT

FIG. 4 shows the frequency response of the plant HRTFs of the OSD system along the different elevations. There are several distinct dips seen in the frequency response above 5 kHz. The frequencies giving the dips goes up as the elevation of the control transducers becomes larger (in the ‘up’ direction) in the front hemisphere, then goes down again as the elevation continuously becomes larger (in the ‘down’ direction). The frequencies to associated with these dips are roughly symmetric with respect to the frontal plane, and hence are likely to be a source of the front and back reversals. On the other hand, they are distinctively different in the vertical direction. Therefore, up-down reversal is expected to be much less likely to happen than the front-back reversal from the viewpoint of the similarity of the spectral shapes.

In general, the response is stronger in the front half than in the rear half. The response at the rear bottom quarter has numerous dips and generally is weaker, and therefore, this region seems to be less useful as a control transducer location. On the other hand, the region centred around 90° elevation (between 60° and 120° elevations) draws attention since the plant has a relatively flat smooth response without any prominent dips. This characteristic of the plant response is an additional and physically supported benefit to just being on the border between the frontal and rear hemispheres. A drawback of the overhead position is that high frequency response above 12 kHz is weaker than that for the directions towards the front.

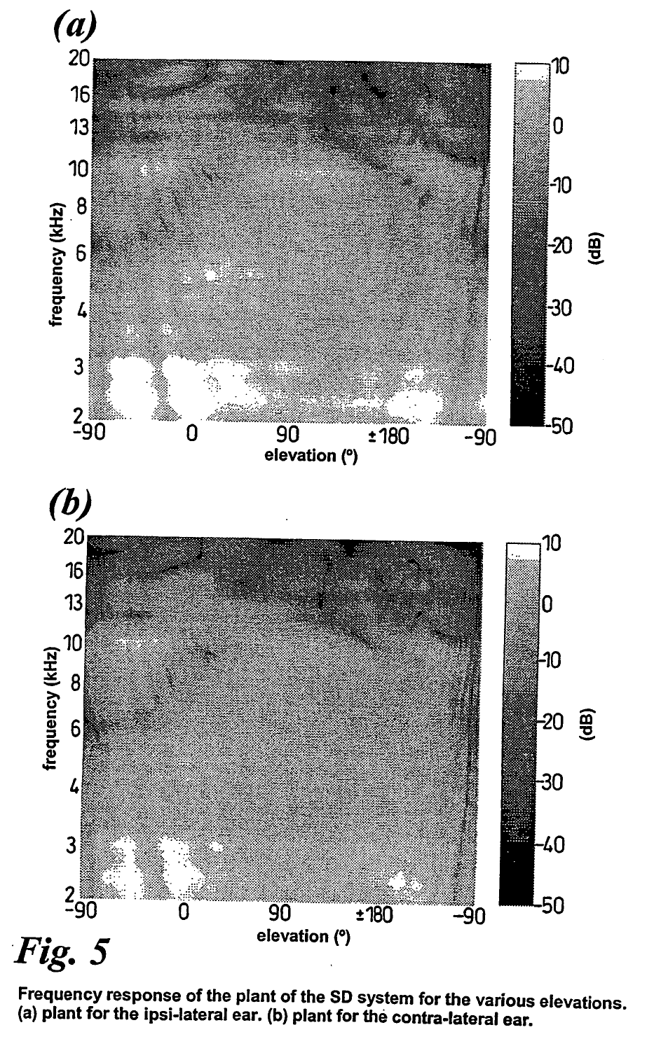

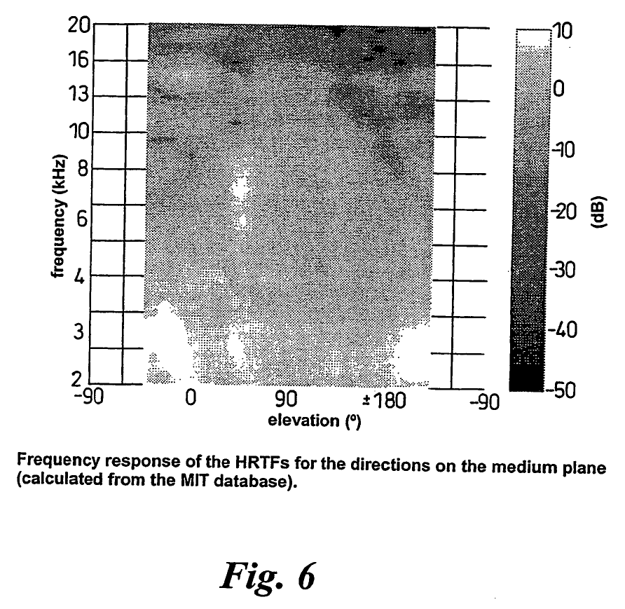

The frequency response of the plant of the SD system along different elevations is shown in FIG. 5. The general tendency is the same as the OSD system, except that the control transducers for the SD system have less response above 12 kHz. In fact, the elevation dependency of the spectrum shape is relatively steady regardless the azimuth direction. This can be seen in [4] showing the response on ±50° azimuth direction as well as the response along the directions on the median plane (FIG. 6). The most noticeable azimuth dependency is that the slope formed by the dip in frequency response as the elevation changes becomes shallower as the sound source moves away from the median plane.

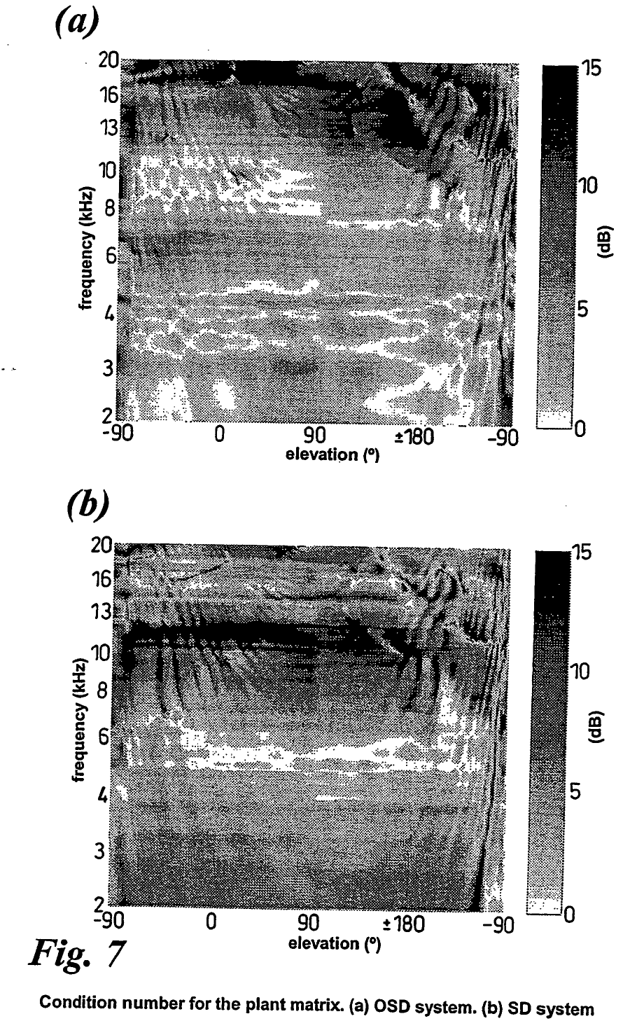

The condition numbers for the plant matrix of the OSD and SD system are shown in FIG. 7. FIG. 7a suggests that the frontal hemisphere is the better location for the control transducers although there may be a consequence that the discretisation of the ideal OSD was optimised for the frontal hemisphere. FIG. 7b suggests a similar result although the picture is smeared by the non-controlled region inherent in the SD system around the 10 kHz to 12 kHz. It is worth noting that this ill-conditioned frequency coincides with the characteristic dips with elevation dependency at around 0° and ±180° elevations (horizontal plane). This may explain the stronger tendency by the SD system of bias error towards the horizontal plane.

### 3. DYNAMIC CUES

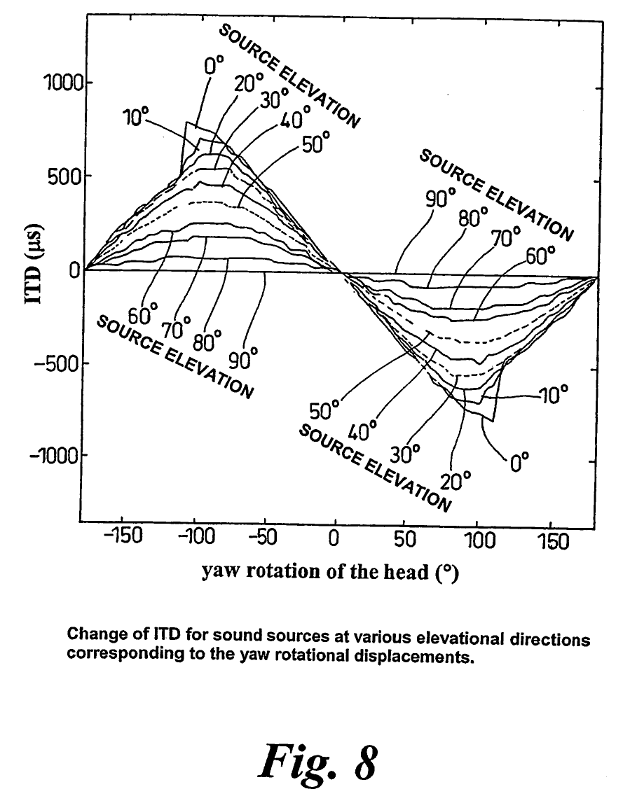

It is also known that when the listener has ambiguity in judging whether the sound is from front or from the rear with spectral cues, he may make use of the dynamic change of cues with respect to head movement. FIG. 8 shows the interaural time difference (ITD) in conjunction with the yaw rotational movement, which is likely to be used to front-back discrimination. In addition, the yaw rotation is by far the most likely form of movement in the course of the object localisation process by all the senses including vision. The ITD is calculated in the same way as that described in [4]. The sound source is on the median plane at the elevations from 0° to 90° with 10° increments. The ITDs given by the yaw rotation of the head from −180° to 180° are plotted in order to illustrate the ITD change by the sound sources in the upper hemisphere. The ITD change due to the sound sources in the lower hemisphere shows a similar tendency but is not illustrated here. The slopes of the ITD curves show the dynamic change of ITD in accordance with its elevation. Most of the frontal source directions produce negative change and rear directions corresponds to positive change.

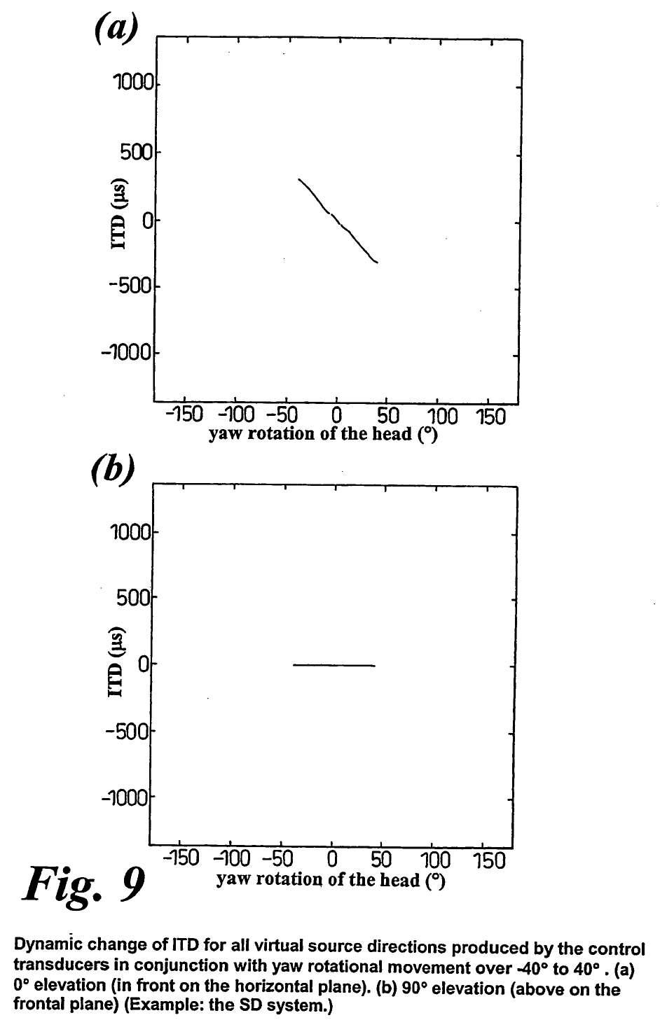

When the control transducers are at 0° elevation (in front on the horizontal plane), as has been used in many trials, the yaw rotational movement always produces a negative change of ITDs, more specifically, a negative value corresponding to the frontal source at 0° elevation. This is illustrated in FIG. 9a showing an example of the ITD change due to a yaw rotation from −40° to 40°. However, when the control transducers are at 90° elevation (on the frontal plane), the yaw rotational movement does not produce any ITD change (FIG. 9b), which is only the case when the sound source is directly above or below the head in the real acoustic environment. Therefore, even though it does not give additional information to resolve the front-back ambiguity, it will not give ‘wrong’ cues that may result in systematic bias error (in this example, bias towards the front).

The head movement should be restricted, in principle, for the synthesis of virtual acoustic environments unless the control filters are adjusted according to the head movement. However, there will often be some uncontrollable head movement or errors in adjusting the control filters in accordance with the head movement, especially in practical conditions. Therefore, placing the control transducers in positions in the frontal plane, especially in the upper hemisphere (above the head), has an advantage over other locations.

### 4. OTHER CONSIDERATIONS

It is a known phenomenon that when a listener has ambiguity in judging the height of the sound source, humans tend to take directions in the horizontal plane as a default, since this is most likely to happen in the real acoustic environment.

Therefore, concern about bias perception in the up-down direction would be somewhat relaxed.

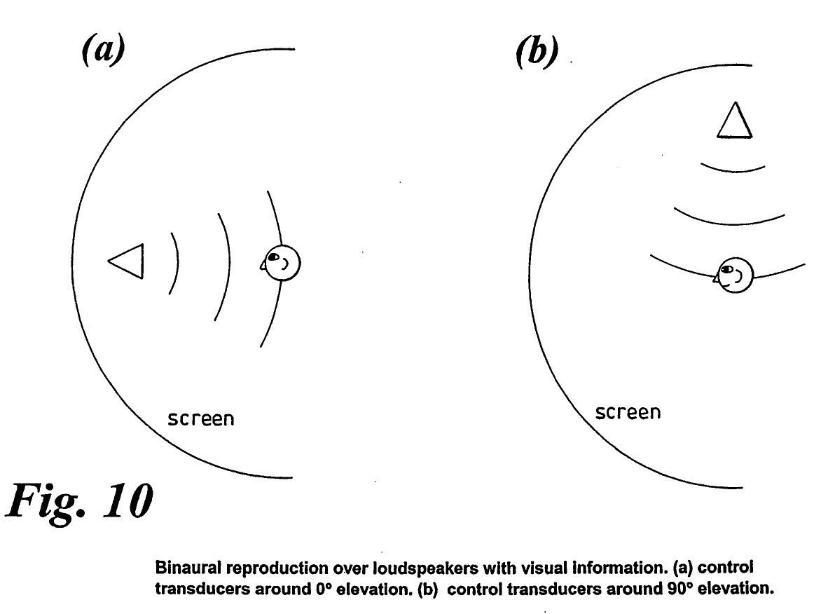

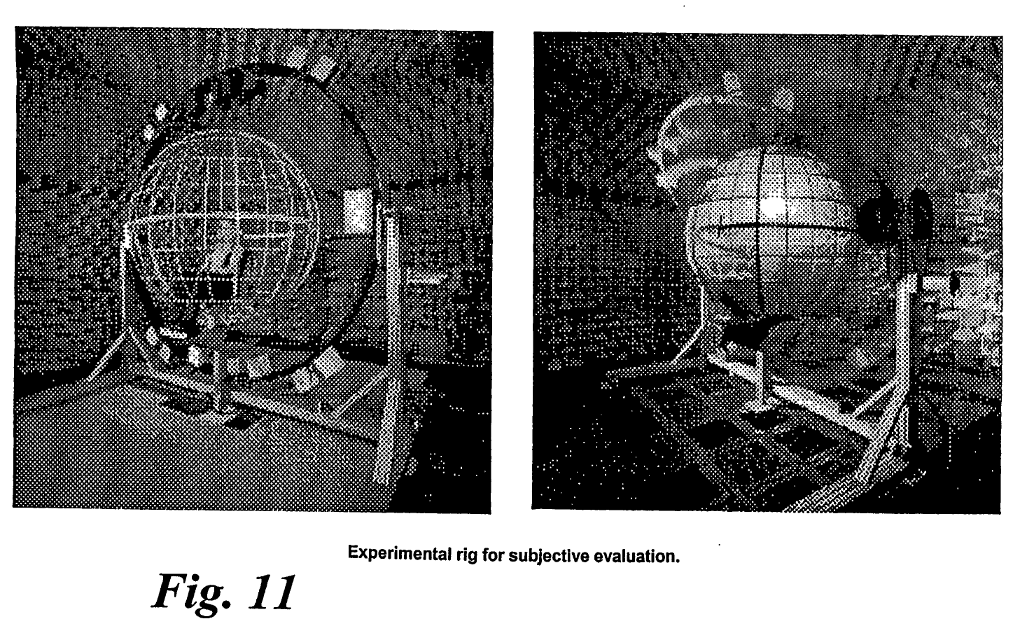

When virtual visual information as well as acoustic information is to be presented to the subject, it is preferable to avoid the existence of the transducers in the listener's sight. This is especially important for systems that aim to present virtual visual information over the whole field of vision of the listener. This implies that elevation directions between −90° and 90° are best avoided (FIG. 10).

### 5. SUBJECTIVE EXPERIMENTS

The analysis above strongly suggests that 90° elevation (in the frontal plane in the upper hemisphere) seems to have several advantages and provides a possible alternative to the usual location at 0° elevation (in the horizontal plane in front). A pair of subjective evaluations were carried out in order to confirm this observation. A localisation experiment for the OSD system is carried out for both 0° elevation and 90° elevation. Another localisation experiment with the false dynamic information induced by a head rotation is also carried out.

### 5. EXPERIMENTAL PROCEDURE

The inverse filters were implemented with a digital signal processor. Among a number of methods described in [2], the inverse filter matrix H was designed from a single 2 by 2 plant matrix. Three young adults who all had normal hearing with no history of hearing problems, served as paid volunteers. The evaluation was performed in an anechoic chamber.

Presentation of a single incident sound wave from various directions is investigated as it is the very basic element consisting of complex sound environment. Pink noise was used as the source signal because of its flat response on a logarithmic frequency scale. The HRTF database measured at MIT Media Lab [5] was used for the binaural filters corresponding to each sound wave directions.

An adjustable chair and a small head-rest were used in order to ensure the head to be positioned correctly regardless the inter-subject difference in body size. It is believed that the subject's head was always within ±10 mm of the correct position. The headrest constrained head movement very well, especially the rotational movement which could give false localization cues to subjects. A spherical grid made of thin metal wires surrounded the subject's head in order to give a guide to work out coordinates of perceived directions (FIG. 11). The grid is painted in light blue and formed a vertical polar coordinate system with a radius of 1 m. The subjects were expected to be more familiar with this coordinate system compared to the interaural polar coordinate system. There were wires every 15° that were labelled with red numbers for azimuth and blue numbers for elevation directions. It was found in preliminary experiments that the subjects can produce a large error when they report a direction without seeing the reference coordinate system. The magnitude of the error in reporting the coordinate is as large as 40° especially when the direction is in the rear hemisphere. The visible coordinate reference reduces this error down to about 5° at the expense of increasing visual related error mainly in the front hemisphere where localisation accuracy is much finer than 5°. A thin black acoustically transparent fabric surrounded the subject supported by the wires in order to minimize the effect of visual information. The subjects could not see anything outside the screen.

A set of 59 stimuli of pink noise with synthesized direction with a duration of 2 seconds each with a gap of 0.5 s were presented prior to each set of tests. The directions used were different from those of used for the later localization test.

The sequence of the stimuli was consistent with vertical polar coordinate system. The purpose of this session was to let subjects become familiar with the sound source signal and sound environment both of which are extremely unusual to them. After a short break, a set of localisation tests were performed.

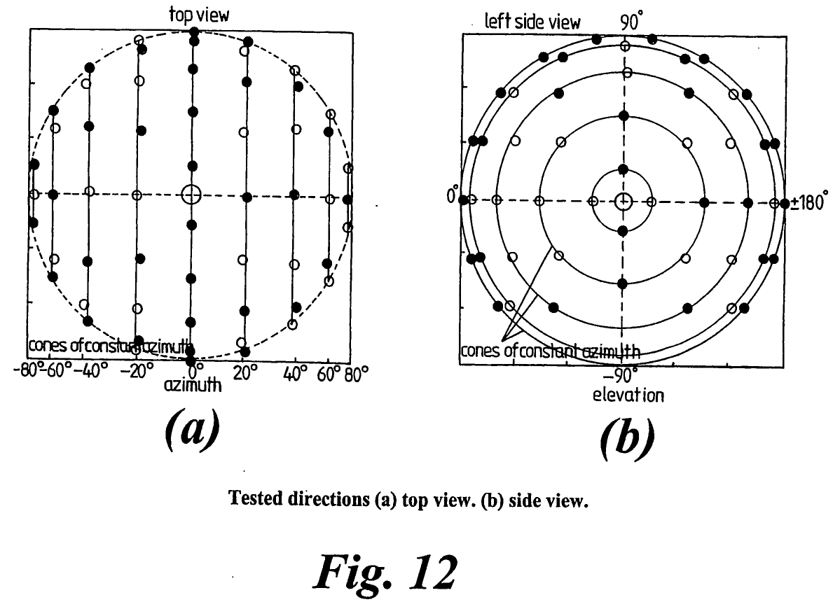

Each stimulus consisted of a reference signal and a test signal. A reference signal was presented at 0° azimuth and 0° elevation, i.e., directly in front of the listener before each test signal. Both signals had the same sound source signal with a duration of 3 seconds for the reference signal and 5 seconds for the test signal with a gap of 3 seconds in between. Directions shown in FIG. 12 were chosen for the presentation ensuring equal sampling density from all spherical directions except downwards. They were selected so that each of them is approximately on one of the cones of constant azimuth directions at −80°, −60°, −40°, −20°, ±0°, +20°, +40°, +60°, or +80° in the interaural polar coordinate system. If there were two directions symmetric with respect to the median plane, one of them was omitted to reduce the test duration. Solid dots represent the directions that were used for the localisation tests. The directions that were omitted are denoted by open circles. In order to avoid the effect of presentation order, the order of presentation was randomised. The reference signal not only cancelled the order effect, but also gave subjects prior knowledge of the sound source signal spectrum that is important for the monaural spectral cue.

The subject was instructed to look straight ahead and not to move the head nor body while the stimuli were presented in order to avoid introducing dynamic cues that relate to head movement. The subject's movement was monitored by the experimenter to ensure the instruction was obeyed. The subject's head was not physically fixed but the subjects were instructed to lean against the headrest. The subject was instructed to turn his head after each test stimulus had stopped to evaluate the direction of the sound and state this to the experimenter. The stimuli, a set of reference and test signals, were repeated when subjects had difficulty in making a judgement. The subjects were allowed to choose more than one direction when they perceived two or more separate directions of sound. However, there were only a few cases where such judgement occurred.

### 5.2 LOCALISATION PREFORMANCE WITH THE CONTROL TRANSDUCERS ABOVE THE HEAD.

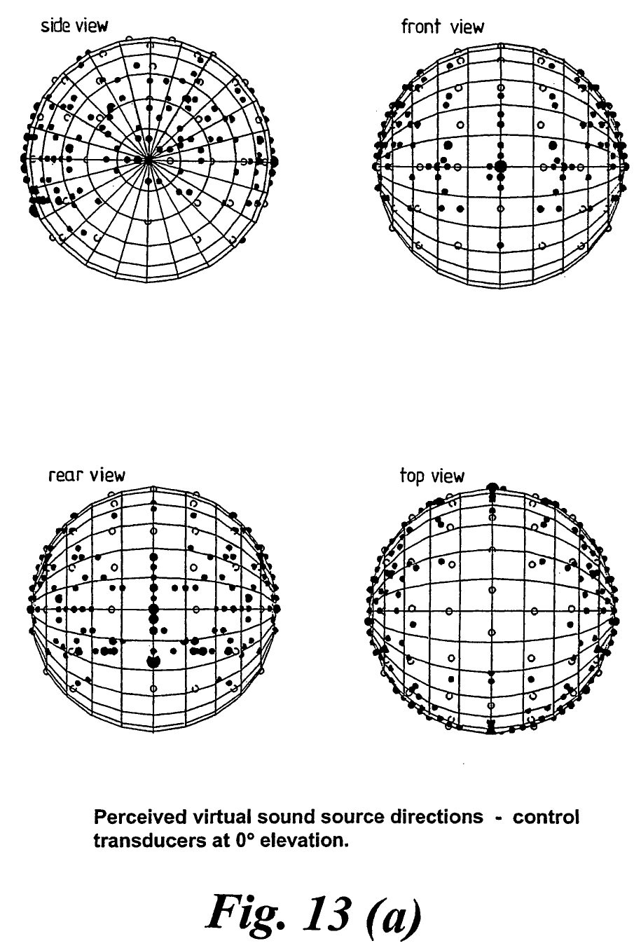

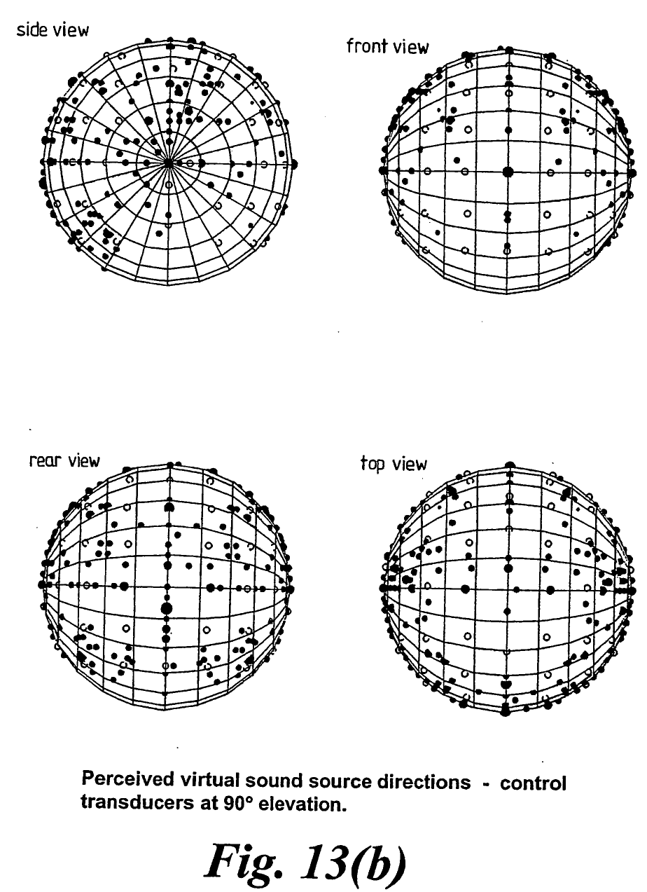

The perceived virtual sound source directions are shown in FIG. 13. Solid dots represent the directions that are perceived and its size represents the number of occurrence of the perception. The presented directions are denoted by open circles. FIG. 13a shows the results for the 0° elevation control transducer location. The responses are clustered towards the horizontal plane (0° and ±180° elevation). There is little perception in the region above and below the head. FIG. 13b shows the results for the 90° elevation control transducer locations. The responses are more evenly spread over various elevations. Nevertheless, a cluster around 80° (near the transducer elevation) is noted as well as that of around −140° (lower rear quarter). There is relatively little perception in the lower front quarter. The characteristics shown by the control transducers at 90° elevation seem particularly suitable for the presentation of virtual acoustic environments together with visual information. This is because the image given by the visual system is likely to shift the auditory perception towards the front, therefore reducing the errors.

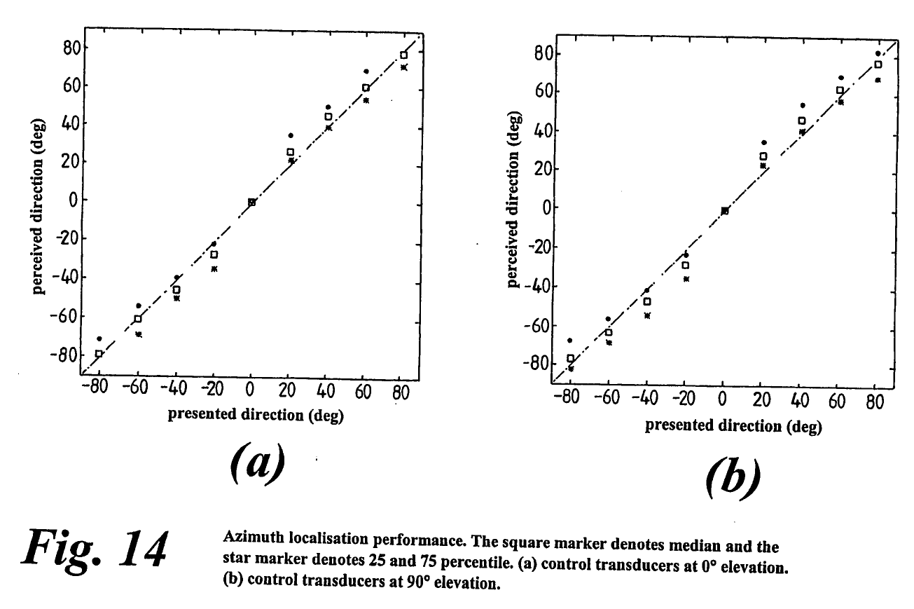

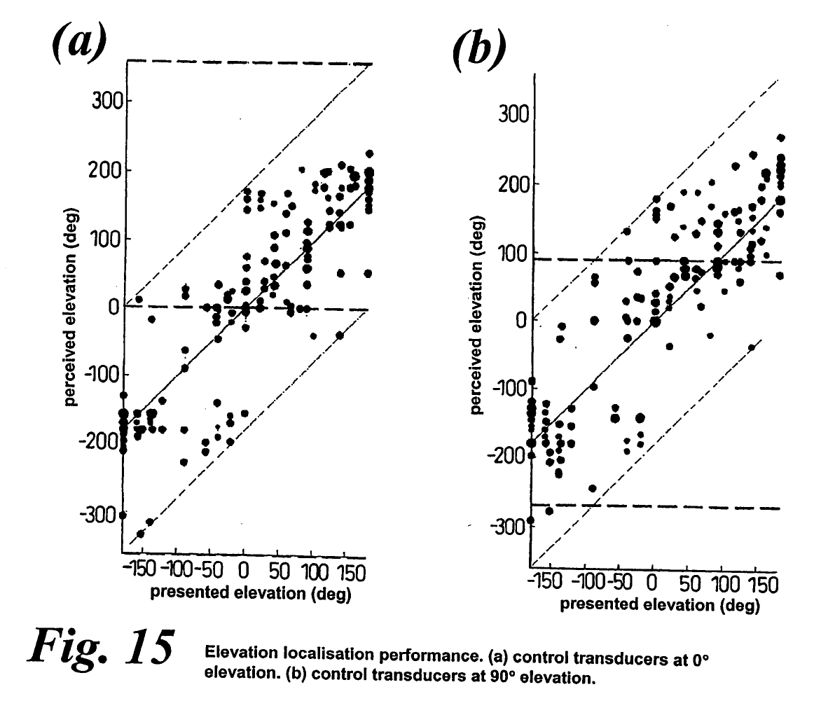

The perceived directions are decomposed into the azimuth directions and elevation directions and shown in FIG. 14 and FIG. 15. Both of the two elevation transducer locations showed very good azimuth localisation performance. In FIG. 14, the median values (the square marker), 25 percentiles and 75 percentiles (the star marker) of the all the responses presented to each azimuth direction are plotted. There is little difference between the two. Conversely, the elevation localisation proved to be much more difficult with both transducer locations. Therefore, all the responses are plotted in FIG. 15 and the size of each solid dot represents the number of responses at that direction. The dashed line shows the direction of the control transducers. The cluster around the horizontal plane is noted in FIG. 15a which shows the response by the 0° transducer elevation. FIG. 15b produced by the 90° transducer elevation shows less biased responses although the results are somewhat scattered.

### 5.3 EFFECT OF THE FALSE DYNAMIC CUE

Another set of localisation experiments with false dynamic information induced by listener head rotation was carried out. An initial experiment where a yaw rotation of ±3° was continuously induced by the subject himself showed little difference in localisation performance. The observation supports the superiority of the spectral cue over the dynamic cue. However, in order to investigate the difference in two different control transducer elevations, the yaw rotation was increased to ±5°.

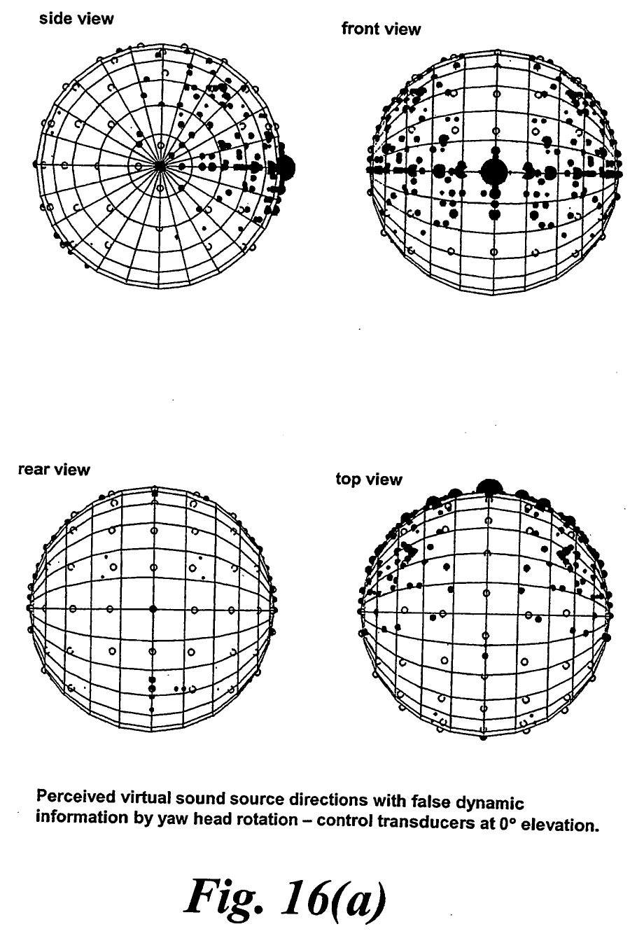

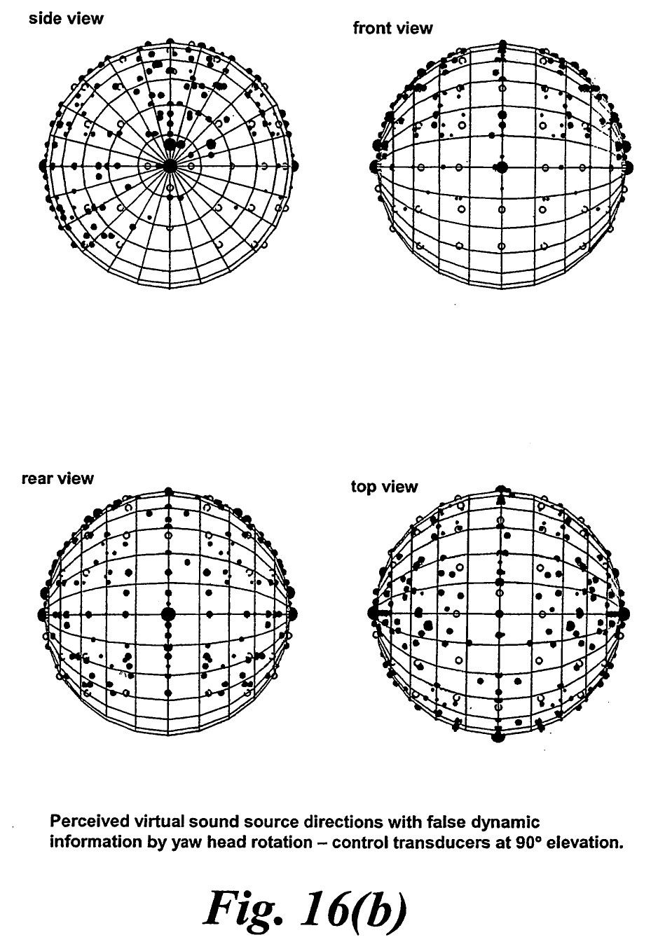

The perceived virtual sound source directions are shown in FIG. 16. In FIG. 16a, it is clear that the perception is biased completely towards the front hemisphere, comparing with FIG. 13a. There is very little response in the rear of the subject. There is a notable difference of the perception of the virtual sound sources on the median plane compared to the other azimuth directions. There, the virtual sources for all the elevations collapsed not only towards the front but also on to the horizontal plane where the control transducers are located. This is not the case for other azimuth directions for which only the bias error towards the front hemisphere is outstanding. The elevation cues other than the front-back discrimination are more robust here than on the median plane and supports the importance of the binaural spectral shape cue [6]. On the contrary, little change in bias localisation error is observed in FIG. 16b.

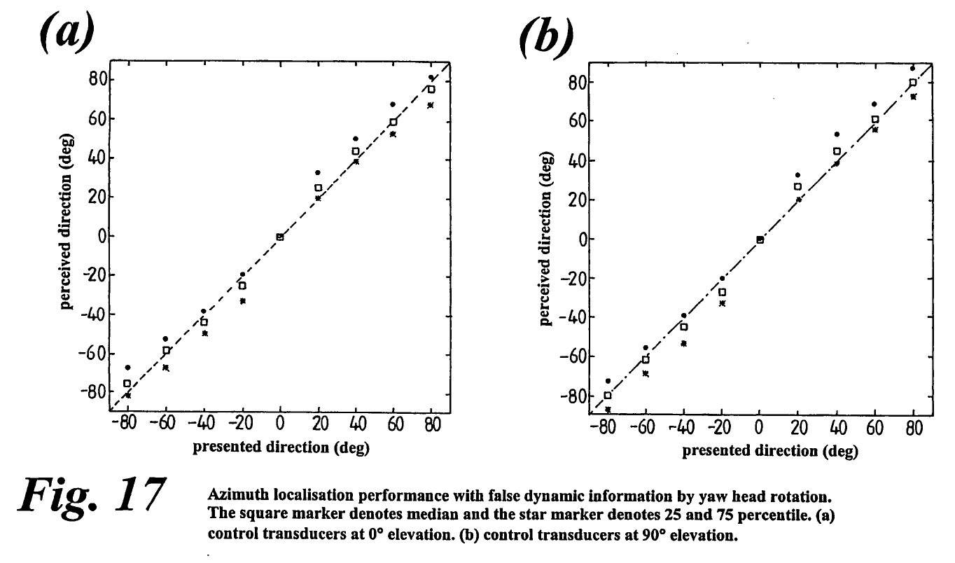

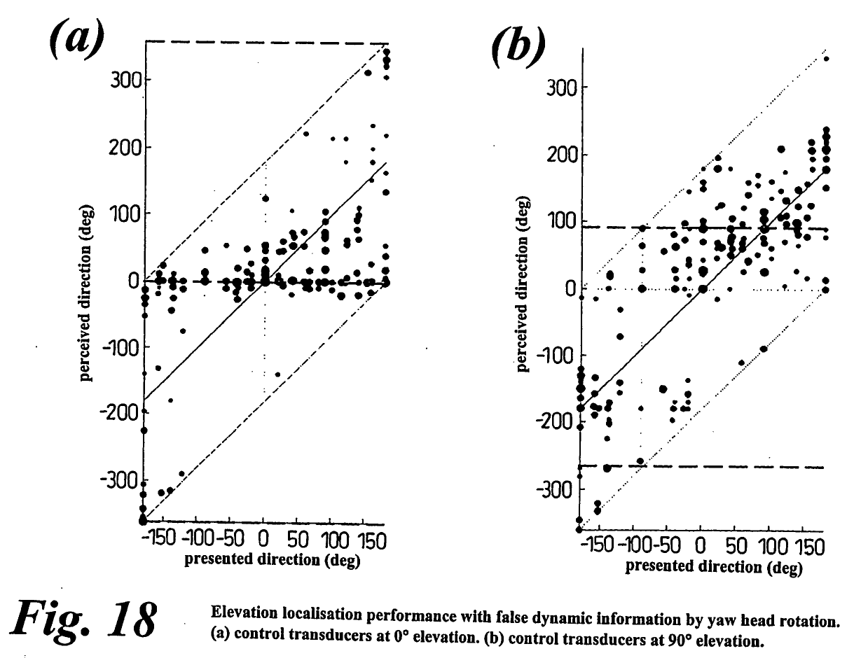

The results for the azimuth directions and elevation directions are shown in FIG. 17 and FIG. 18. Again, both of the two alternative transducer locations showed very good azimuth localisation performance. There is little difference between the two. On the contrary, there is a significant difference in elevation localisation between the two different transducer locations. Most of the perceptions are clearly biased towards the control transducer elevation when they are at 0° elevation. However, the bias is not at all as strong when the control transducers are at 90° elevation.

### 6 CONCLUSIONS

In order to establish the characteristics of the various elevation positions of the control transducers, the analysis of the spectral cues and dynamic cues as well as a set of subjective experiment has been performed. The frequency response of the plant supports that promising control transducer positions are in the frontal plane above the listener's head. The condition of the plant matrix shows the disadvantage of locations in the rear hemisphere. An analysis of the dynamic cues induced by unwanted head rotation strongly supports the transducer location on the frontal plane. A subjective experiment was performed in order to compare between two alternative control transducer locations; on the horizontal plane in front of the listener and on the frontal plane above the listener's head. The results without false dynamic cues show that both can perform equally well, with different advantages and disadvantages. However, the control transducer location above the head clearly shows the advantage of discriminating against false dynamic information.

The characteristics of the localisation error support that the transducer location above the head is especially suitable when visual information is presented at the same time as audio information.

References

[1] P. A. Nelson, O. Kirkeby, T. Takeuchi, and H. Hamada, ‘Sound fields for the production of virtual acoustic images,’ J. Sound. Vib. 204 (2), 386-396 (1997).

[2] T. Takeuchi and P. A. Nelson, ‘Optimal source distribution for virtual acoustic imaging,’ ISVR Technical Report No.288, University of Southampton (2000).

[3] T. Takeuchi, P. A. Nelson, O. Kirkeby and H. Hamada, ‘Influence of Individual Head Related Transfer Function on the Performance of Virtual Acoustic Imaging Systems’, 104th AES Convention Preprint 4700 (P4-3), (1998).

[4] T. Takeuchi, and P. A. Nelson, ‘Robustness of the Performance of the ‘Stereo Dipole’ to Head Misalignment,’ ISVR Technical Report No.285, University of Southampton (1999).

[5] B GARDNER and K MARTIN, 1994, HRTF Measurements of a KEMAR Dummy-Head Microphone, MIT Media Lab Perceptial Computing—Technical Report No. 280

[6] C. Lim, and R. O. Duda, ‘Estimating the Azimuth and Elevation of a Sound Source from the Output of a Cochlea Model,’ Proc. Twenty-eighth Annual Asilomer Conference on Signals, Systems and Computers (IEEE, Asilomar, CA), 399-403 (1994).

1. A sound reproduction system comprising electro-acoustic transducer means, and transducer drive means for driving the electro-acoustic transducer means in response to a plurality of channels of a sound recording, the electro-acoustic transducer means comprising sound emitters which are spaced-apart in use, the transducer drive means comprising filter means that has been designed and configured with the aim of reproducing at a listener location an approximation to the local sound field that would be present at the listener's ears in recording space, taking into account the characteristics and intended positioning of the sound emitters relative to the ears of the listener, and also taking into account the head related transfer functions of the listener, characterised in that the electro-acoustic transducer means comprises at least one pair of sound emitters that are spaced from the interaural axis of the listener at the listener location and positioned substantially in a plane that includes said interaural axis and is inclined relative to a reference horizontal plane that also includes said interaural axis, the angle of inclination of said inclined plane relative to said horizontal plane being in range 60° to 120°.

2. A sound reproduction system as claimed in claim 1 in which the pair of transducers are positioned higher than the head.

3. A sound reproduction system as claimed in claim 1 in which the angle of inclination is in the range 75° to 105°.

4. A sound reproduction system as claimed in claim 1 in which the pair of transducers are positioned in the frontal hemisphere.

5. A sound reproduction system as claimed in claim 1 in which the electro-acoustic transducer means comprises a plurality of pairs of transducers.

6. A sound reproduction system as claimed in claim 5 in which the pairs of transducers are located substantially in a common inclined plane.

7. A sound reproduction system as claimed in claim 5 in which the electro-acoustic transducer means comprises a pair of transducers that are positioned substantially on the interaural axis, on the opposite sides of the head position.

8. A sound reproduction system as claimed in claim 5 in which a relatively higher frequency band of the drive output signals is arranged to excite a first of said pairs of sound emitter that subtend a relatively small azimuth angle at the listener head position, and a relatively lower frequency band of the drive output signals is arranged to excite a second of said papers of sound emitters that subtend a relatively larger azimuth angle at the listener head position.

9. Filter means designed and configured to be suitable as the filter means of the transducer drive means of the sound reproduction system according to any of the preceding claims.

10. A computer-readable medium on which is stored code representing the filter coefficients of the filter means of claim 9, suitable for use in creating an operative filter means.
